(19) United States
(12) Patent Application Publication
(10) Pub. No.: US 2026/0081821 A1
(43) Pub. Date: Mar. 19, 2026

(54) Technologies for Isolating Channel Layer Services

(71) Applicant: The PNC Financial Services Group, Inc., Pittsburgh, PA (US)

(72) Inventors: Kevin Cooney, Pittsburgh, PA (US); Nathan Starner, Pittsburgh, PA (US); Michael Protulipac, Pittsburgh, PA (US); Daniel Servich, Pittsburgh, PA (US)

(21) Appl. No.: 19/322,852

(22) Filed: Sep. 9, 2025

Related U.S. Application Data
(60) Provisional application No. 63/696,549, filed on Sep. 19, 2024.

(51) Int. Cl. H04L 41/0663

(52) U.S. Cl. CPC H04L 41/0663

(57) ABSTRACT

Technologies for isolating channel layer services include a system with circuitry configured to perform operations associated with multiple channels in a distributed computer architecture that includes resources in multiple data centers. The circuitry may be further configured to determine, as a function of the performance of the operations, whether a status of a resource in the distributed computer architecture is indicative of a malfunction, including determining a channel affected by the malfunction. Additionally, the circuitry may be configured to redirect traffic associated with the affected channel from the resource associated with the malfunction to a secondary resource of the distributed architecture to reduce an effect of the malfunction across the channels. Other embodiments are also described and claimed.

### RELATED APPLICATIONS

This application claims the benefit of U.S. Provisional Application No. 63/696,549 filed Sep. 19, 2024 for “Technologies for Isolating Channel Layer Services,” which is hereby incorporated by reference in its entirety.

### BACKGROUND

Large organizations typically have a combination of subsystems through which computerized interactions or transactions occur (e.g., in connection with computers of customers or third parties). Further, in conventional systems, each of the paths (e.g., channels) through which data communications (e.g., traffic) occur have at least one single point of failure. That is, if a subsystem, such as a database subsystem fails, all of the channels are adversely affected and may become inoperative.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for isolating channel layer services;

FIG. 2 is a diagram of at least one embodiment of a compute device of the system of FIG. 1;

FIGS. 3-6 are flowcharts of at least one embodiment of a method for isolating channel layer services that may be performed by the system of FIG. 1; and

FIG. 7 is a diagram of an embodiment of the system of FIG. 1 with reconfigured traffic associated with a channel in response to detection of a malfunction.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

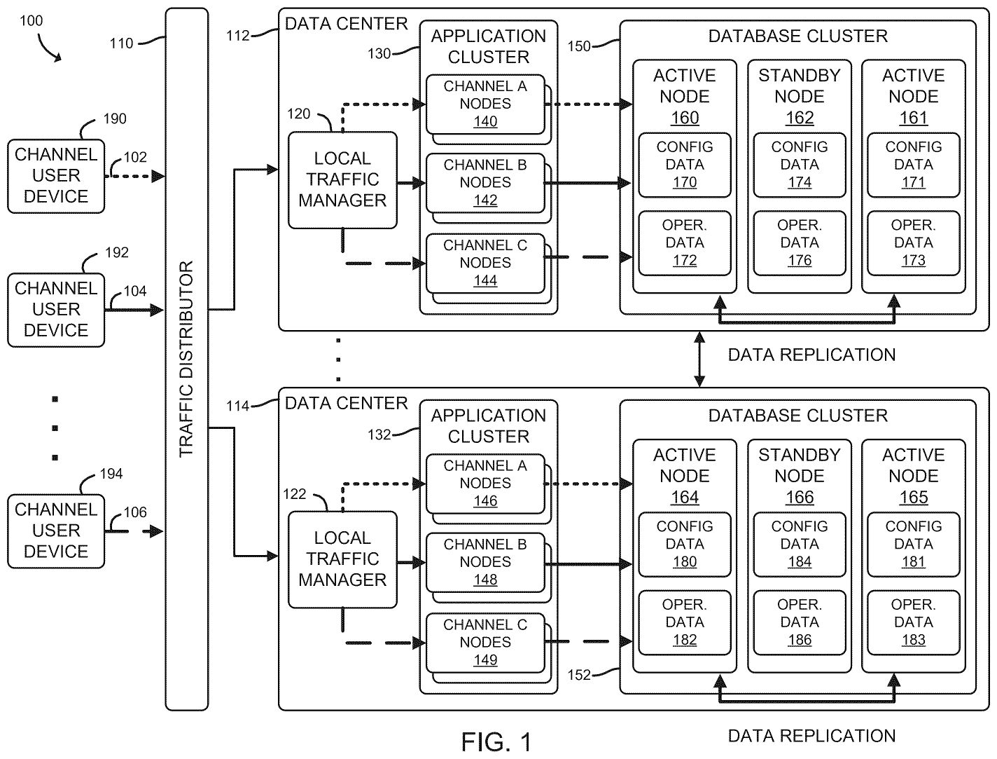

Referring now to FIG. 1, a system 100 for isolating channel layer services has a distributed architecture that includes a traffic distributor 110 communicatively connected to a set of data centers 112, 114 and to channel user devices 190, 192, 194. The traffic distributor 110 selectively routes traffic (e.g., data communications) pertaining to each of multiple channels 102, 104, 106 among the data centers 112, 114 based on multiple factors, including geography (e.g., routing traffic to the geographically nearest data center to the associated channel user device 190, 192, 194), load balancing, and/or operational status of the resources within the data center 112, 114. The channels 102, 104, 106 may each be embodied as a path through which data communications are sent through the system 100 and for which one or more corresponding services (e.g., application layer operations, such as computation, user interface interactions, and the like, and data layer operations, such as writing to and/or reading data from corresponding databases) are performed. In the illustrative embodiment, the channel 102 (Channel A) corresponds to web based traffic, such as data communications associated with web standards (e.g., published by the World Wide Web Consortium), such as hypertext transfer protocol (HTTP), hypertext markup language (HTML), JavaScript, representational state transfer (REST), and the like. The channel 104, in the illustrative embodiment, corresponds with mobile traffic, such as data communications sent from and to applications executed by mobile compute devices (e.g., smart phones). Further, the channel 106, in the illustrative embodiment, corresponds with help center traffic, such as data communications, including voice communications and/or text communications, sent between a customer of an operator of the system 100 (e.g., an enterprise, such as a financial institution) and the financial institution itself (e.g., personnel operating compute devices of the financial institution, rules-based and/or artificial intelligence based agents, to resolve customer service issues).

Within each data center 112, 114, in the illustrative embodiment, a local traffic manager 120, 122 routes traffic to corresponding nodes 140, 142, 144, 146, 148, 149 in an application cluster 130, 132. The application clusters 130, 132 form an application layer and perform application layer services. Each node 140, 142, 144, 146, 148, 149 represents a resource of the corresponding data center 112, 114 that enables compute operations for an application layer to service requests for the corresponding channel 102, 104, 106 (e.g., web traffic, mobile traffic, help center traffic). Depending on the embodiment, each node 140, 142, 144, 146, 148, 149 may be embodied as a separate compute device (e.g., a rack mounted server), virtual machine (e.g., an abstracted version of an entire computer including CPU, memory, and storage executing a corresponding operating system), or a container (a portable instance of software, including dependencies of the software to be executed on virtualized or physical hardware). In operation, the nodes 140, 142, 144, 146, 148, 149 may access data, such as by reading from and/or writing to data structures (e.g., tables, graphs, or other data structures), such as configuration data 170, 171, 174, 180, 181, 184 and/or operational data 172, 173, 176, 182, 183, 186 maintained by corresponding nodes 160, 161, 162, 164, 165, 166 in corresponding database clusters 150, 152. The database clusters 150, 152 form a data layer and provide data layer services. Like the nodes 140, 142, 144, 146, 148, 149, the nodes 160, 161, 162, 164, 165, 166 may be embodied as separate compute devices (e.g., rack mounted servers), virtual machines, or containers and may perform operations to write to and read from physical data storage media in response to requests from the nodes 140, 142, 144, 146, 148, 149 of the application clusters 130, 132. For each channel 102, 104, 106, the clusters 130, 132, 150, 152 provide corresponding services at their corresponding layer (e.g., application layer, data layer), thereby providing channel layer services (e.g., services of the application layer and the data layer provided for each channel 102, 104, 106). As described in more detail herein, the nodes 140, 142, 144, 146, 148, 149 are configured to utilize a corresponding node of a database cluster 150, 152.

As shown in FIG. 1, the node 140 of Channel A (e.g., for web traffic) is configured to utilize the primary nodes (e.g., active nodes) 160, 161 (which replicate data between them) of the database cluster 150 for data access operations. Further, the node 142 of Channel B (e.g., for mobile traffic) is configured to utilize the primary nodes (e.g., active nodes) 164, 165 (which replicate data between them) for data access operations. Likewise, the node 144 of Channel C (e.g., for help center traffic) is also configured to utilize the primary nodes (e.g., active nodes) 164, 165 for data access operations. Similarly, the node 146 of Channel A (e.g., in the data center 114) is configured to utilize the primary nodes (e.g., active nodes) 164, 165 (which replicated data between them) for data access operations. Further, the node 148 of Channel B in the data center 114 is configured to utilize the primary nodes 164, 165 for data access operations, and the node 149 of Channel C in the data center 114 is configured to utilize the primary nodes 164, 165 for data access operations. However, in response to a determination that a malfunction may be present or may be impending (e.g., likely to occur), the nodes 140, 142, 144, 146, 148, 149 are configured to redirect their traffic to an alternative node of a database cluster. Due to continual data replication between the data centers 112, 114, the nodes 140, 142, 144, 146, 148, 149 may dynamically redirect the traffic for their associated channel without encountering data-related errors. Furthermore, and as described herein, a local traffic manager of the traffic distributor may dynamically redirect traffic among the nodes 140, 142, 144, 146, 148, 149 in response to a determination that a malfunction may be present or impending in any of the nodes 140, 142, 144, 146, 148, 149 of the application clusters 130, 132. Accordingly, and unlike conventional systems where a single point of failure may cause communications across multiple or all channels to fail, the system 100 dynamically detects and isolates malfunctions, thereby preventing a problem (e.g., malfunction) associated with a channel from adversely affecting operations associated with other channels 102, 104, 106 and efficiently redirects traffic associated with the affected channel to resources that are not experiencing a malfunction.

While a relatively small number of compute devices 110, 120, 122, 130, 132, 140, 142, 144, 146, 148, 149, 160, 161, 162, 164, 165, 166, 190, 192, 194 are shown in FIG. 1 for simplicity and clarity, it should be understood that the number of compute devices, in practice, may range in the tens, hundreds, thousands, or more. Likewise, it should be understood that the compute devices 110, 120, 122, 130, 132, 140, 142, 144, 146, 148, 149, 160, 161, 162, 164, 165, 166, 190, 192, 194 may be distributed differently or perform different roles than the configuration shown in FIG. 1. Further, though shown as separate compute devices 110, 120, 122, 130, 132, 140, 142, 144, 146, 148, 149, 160, 161, 162, 164, 165, 166, 190, 192, 194 in some embodiments, the functionality of one or more of the compute devices 110, 120, 122, 130, 132, 140, 142, 144, 146, 148, 149, 160, 161, 162, 164, 165, 166, 190, 192, 194 may be combined into fewer compute devices and/or distributed across more compute devices than those shown in FIG. 1.

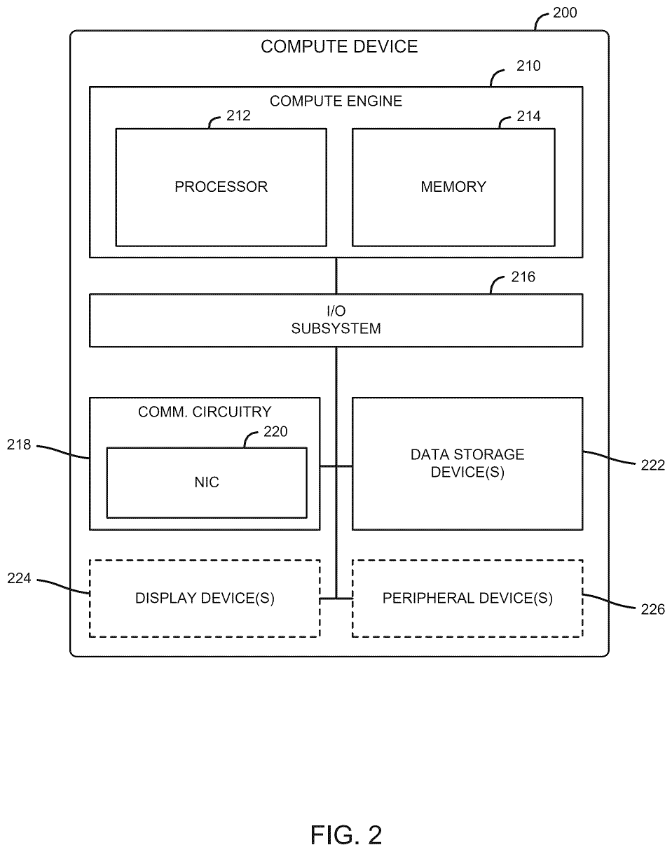

Referring now to FIG. 2, an illustrative embodiment of a compute device 200, representative of each of the compute devices 110, 120, 122, 130, 132, 140, 142, 144, 146, 148, 149, 160, 161, 162, 164, 165, 166, 190, 192, 194 includes a compute engine 210, an input/output (I/O) subsystem 216, communication circuitry 218, and one or more data storage devices 222. In some embodiments, the compute device 200 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as at least one processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), one or more graphics processing units (GPUs), neural processing units (NPUs), and/or floating point units (FPUs), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the compute device 200 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding than a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as configuration data (e.g., internet protocol addresses or other identifiers of compute devices to utilize for defined operations), operational data (e.g., data pertaining to servicing requests associated with the channels 102, 104, 106), applications, libraries, and drivers.

The compute engine 210 is communicatively coupled to other components of the compute device 200 via the I/O subsystem 216, which may be embodied as circuitry and/or components to facilitate input/output operations with the compute engine 210 (e.g., with the processor 212 and the main memory 214) and other components of the compute device 200. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the compute device 200, into the compute engine 210.

The communication circuitry 218 may be embodied as any communication circuit, device, or collection thereof, capable of enabling communications over a network between the compute device 200 and another device (e.g., a compute device 110, 120, 122, 130, 132, 140, 142, 144, 146, 148, 149, 160, 161, 162, 164, 165, 166, 190, 192, 194, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the compute device 200 to connect with another compute device (e.g., a compute device 110, 120, 122, 130, 132, 140, 142, 144, 146, 148, 149, 160, 161, 162, 164, 165, 166, 190, 192, 194, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the compute device 200 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the compute device 200 are housed in a single unit. However, in other embodiments, the components may be in separate housings. It should be appreciated that while the compute device 200 is representative of the devices 110, 120, 122, 130, 132, 140, 142, 144, 146, 148, 149, 160, 161, 162, 164, 165, 166, 190, 192, 194, any of the devices 110, 120, 122, 130, 132, 140, 142, 144, 146, 148, 149, 160, 161, 162, 164, 165, 166, 190, 192, 194 may include other components, sub-components, and devices commonly found in a computing device, which are not discussed above in reference to the compute device 200 and not discussed herein for clarity of the description.

In the illustrative embodiment, the compute devices 110, 120, 122, 130, 132, 140, 142, 144, 146, 148, 149, 160, 161, 162, 164, 165, 166, 190, 192, 194 are in communication via a network, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

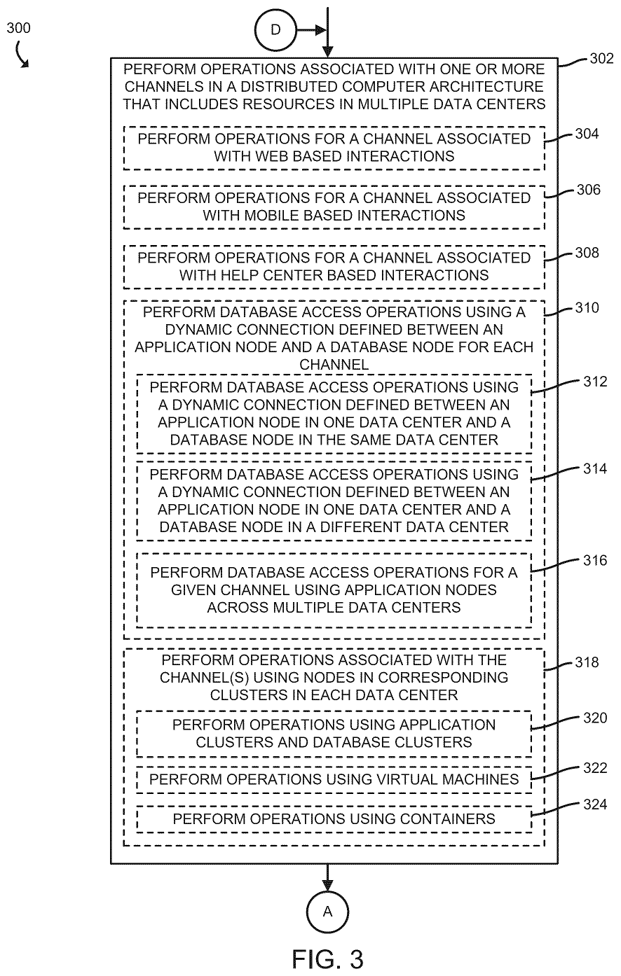

Referring now to FIG. 3, the system 100 may perform a method 300 for isolating channel layer services to mitigate the impact of a malfunction in a resource of a the system 100. The method 300, in the illustrative embodiment, begins with block 302 in which the system 100 performs operations associated with one or more channels (e.g., the channels 102, 104, 106) in a distributed compute architecture that includes resources (e.g., the nodes 140, 142, 144, 146, 148, 149, 160, 161, 162, 164, 165, 166 of the clusters 130, 132, 150, 152) in multiple data centers 112, 114. As indicated in block 304, in performing the operations, the system 100 may perform operations for a channel associated with web based interactions (e.g., the channel 102, Channel A). For example, the system 100 may perform operations associated with requests from a web browser (e.g., executed by the channel user device 190) or from a web based software development kit (SDK), such as an application programming interface (API) call transmitted through a web related protocol, such as one or more web based SDK API calls to authenticate a user or track the identity of a user using Security Assertion Markup Language (SAML 2.0), OAuth 2.0, OpenID Connect (OIDC), or others. The system 100 may perform operations for a channel associated with mobile based interactions (e.g., the channel 104, Channel B), such as responding to requests sent from a mobile compute device (e.g., channel user device 192, which may be embodied as a smart phone executing a mobile application), as indicated in block 306. Similarly, the system 100 may perform operations for a channel (e.g., the channel 106, Channel C) associated with help center based interactions, as indicated in block 308, such as responding to voice or text based customer service inquiries.

In performing operations, the system 100 performs, for each channel 102, 104, 106, database access operations using a dynamic connection defined (e.g., in configuration data, in a driver, etc.) between an application node 140, 142, 144, 146, 148, 149 and a database node 160, 161, 162, 164, 265, 166, as indicated in block 310. The system 100 may perform database access operations using a dynamic connection defined between an application node in one data center and a database node in the same data center (e.g., the application node 140 and the database node 160 in the data center 112), as indicated in block 312. The system 100 may additionally or alternatively perform database access operations using a dynamic connection defined between an application node in one data center and a database node in a different data center (e.g., the application node 146 in the data center 114 and the database node 160 in the data center 112), as indicated in block 314. In some embodiments, the system 100 performs database access operations for a given channel using application nodes across multiple data centers 112, 114, as indicated in block 316. That is, for a given channel (e.g., channel 102, Channel A), application nodes in multiple data centers (e.g., application node 140 in the data center 112 and application node 146 in the data center 114) both perform (e.g., via corresponding requests to database nodes, such as the database nodes 160, 161, 164, 165) data access operations. In some embodiments, all application nodes in a given data center 112, 114 utilize database nodes in the same data center 112, 114 (e.g., to reduce latency). However, in other embodiments, across data centers 112, 114, all application nodes associated with a given channel (e.g., the channel 102, Channel A) may utilize the same database node, regardless of whether that database node is in the same data center 112, 114 as the application node. In some embodiments, application nodes (e.g., node(s) 140) associated with a given channel (e.g., Channel A) may utilize a different set of database nodes than the application nodes (e.g., nodes 142 or 144) associated with another channel (e.g., Channel B or C).

As indicated in block 318, in performing operations associated with the channels, the system 100 uses nodes in corresponding clusters in each data center (e.g., the clusters 130, 150 in the data center 112 and the clusters 132, 152 in the data center 114). In doing so, the system 100 performs the operations using application clusters (e.g., application clusters 130, 132) and database clusters (e.g., the database clusters 150, 152), as indicated in block 320. As discussed above, each cluster includes a set of nodes, which may be embodied as physical compute devices or virtualized resources. Accordingly, as indicated in block 322, the system 100 may perform the operations using virtual machines (e.g., one or more of the nodes 140, 142, 144, 146, 148, 149, 160, 161, 162, 164, 165, 166 may be embodied as virtual machine(s)). Additionally or alternatively, and as indicated in block 324, the system 100 may perform the operations using one or more containers (e.g., one or more of the nodes 140, 142, 144, 146, 148, 149, 160, 161, 162, 164, 165, 166 may utilize or be embodied as one or more containers (e.g., using Red Hat OpenShift or other containerization platform)).

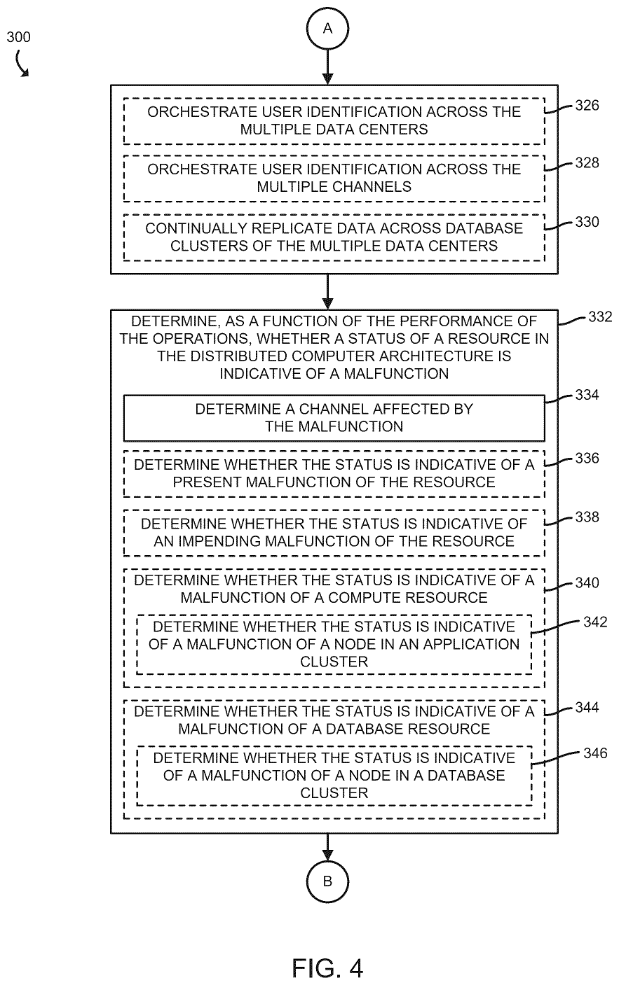

Referring now to FIG. 4, in performing the operations, the system 100 may orchestrate user identification (e.g., authentication data, user identification data, etc.) across the multiple data centers 112, 114, as indicated in block 326. The orchestration may be based at least in part on ongoing replication of data across the data centers 112, 114, and/or an identity orchestration platform (e.g., FlexID). Relatedly, and as indicated in block 328, the system 100 may orchestrate user identification across the multiple channels (e.g., enabling a determination that traffic from one channel (e.g., the channel 102) pertains to the same user as traffic associated with another channel (e.g., the channel 106)), thereby enabling efficient determination that a help center request may pertain to a contemporaneous web based interaction of a user). As indicated in block 330, the system 100, in the illustrative embodiment, continually replicates data across database clusters 150, 152 of the multiple data centers 112, 114.

Continuing the method 300, the system 100 determines, as a function of (e.g., based on) the performance of the operations (e.g., from block 302), whether a status of a resource in the distributed computer architecture is indicative of a malfunction, as indicated in block 332. In doing so, and as indicated in block 334, the system 100 determines the channel (e.g., channel 102, 104, 106) affected by the malfunction (e.g., based on an association (e.g., defined in configuration data indicating allocation of nodes to channels) between the channels and the resources (e.g., nodes) used to perform the operations for the channels). As indicated in block 336, the system 100 may determine whether the status is indicative of a present (e.g., currently existing) malfunction of the resource. Alternatively, and as indicated in block 338, the system 100 may determine whether the status is indicative of an impending (e.g., having a likelihood to occur within a relatively short time period) malfunction of the resource. The system 100 may determine whether the status is indicative of a malfunction of a compute resource, as indicated in block 340. For example, the system 100 may determine whether the status is indicative of a malfunction of a node in an application cluster (e.g., a node 140, 142, 144 in the application cluster 130 or a node 146, 148, 149 in the application cluster 132), as indicated in block 342. The system 100 may determine whether the status is indicative of a malfunction of a database resource, as indicated in block 344. In doing so, the system 100 may determine whether the status is indicative of a malfunction of a node in a database cluster (e.g., a node 160, 161, 162 in the database cluster 150 or a node 164, 165, 166 in the database cluster 152), as indicated in block 346.

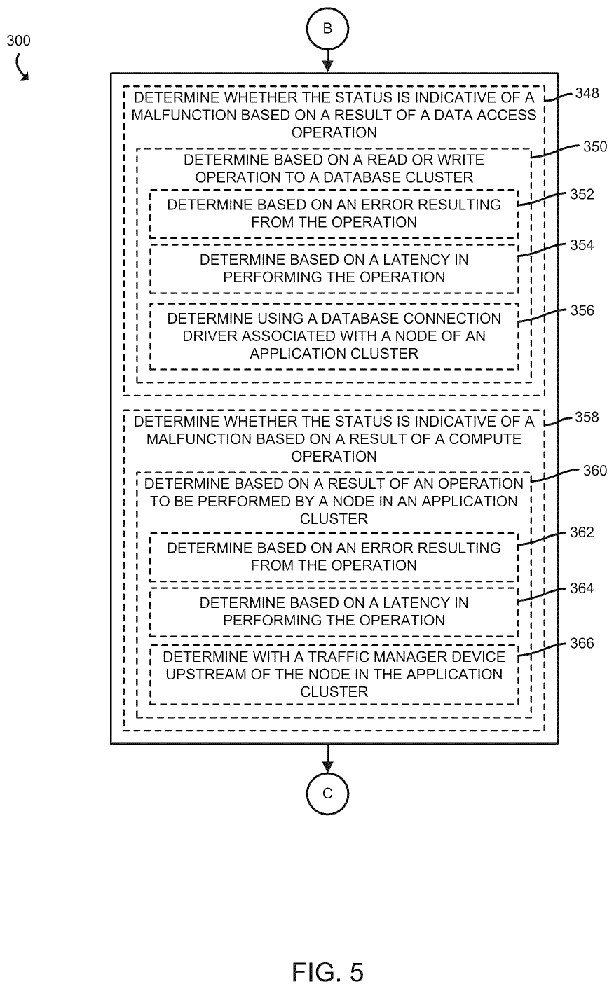

Referring now to FIG. 5, in determining whether a status of a resource is indicative of a malfunction, the system 100 may determine the status based on a result of a data access operation (e.g., completion of a data access operation or an attempt to perform a data access operation), as indicated in block 348. For example, and as indicated in block 350, the system 100 may determine the status based on a read or write operation (e.g., via a corresponding request sent from a node 140, 142, 144, 146, 148, 149 in an application cluster 130, 132) to a database cluster 150, 152. The system 100 may determine the status based on an error resulting from the operation, as indicated in block 352. For example, the system 100 may determine the status based on an error message returned (e.g., to the application node 140, 142, 144, 146, 148, 149 that sent a data access request) from a corresponding node 160, 161, 162, 164, 165, 166 in the database cluster 150, 152, indicating that the requested data was not found, that the data is corrupt, or that a write to the underlying data storage device failed. In some embodiments, the application node 140, 142, 144, 146, 148, 149 may determine that an error is present even in the absence of an error message from the database cluster 150, 152, such as by determining that data returned from the database cluster does not conform to an expected format, does not satisfy a checksum, or is otherwise malformed. As indicated in block 354, the system 100 may determine the status based on a latency in performing the data access operation. For example, if the operation takes more than a defined time period to complete, the system 100 may determine that an underlying malfunction may be present in the database cluster 150, 152 that was requested to perform the operation. As indicated in block 356, the system 100 may perform the determination of the status using a database connection driver (e.g., a Java Database Connectivity (JDBC) driver, an Open Database Connectivity (ODBC) driver, or other software component that enables communication between an application and a database management system through application programming interface (API) calls) associated with a node of an application cluster 130, 132 (e.g., the node 140, 142, 144, 146, 148, 149 that sent the data access request to a corresponding database cluster 150, 152).

The system 100 may determine whether the status is indicative of a malfunction based on a result of a compute operation (e.g., an attempted or completed compute operation), as indicated in block 358. In doing so, and as indicated in block 360, the system 100 may determine the status based on a result of an operation to be performed by a node 140, 142, 144, 146, 148, 149 in an application cluster 130, 132. The system 100 may determine the status based on an error resulting from the operation, as indicated in block 362. The error may be indicated in error message reported by the corresponding node 140, 142, 144, 146, 148, 149 or the system 100 may determine that an error is present based on a determination that a response from the node 140, 142, 144, 146, 148, 149 does not match an expected response (e.g., an unparseable or otherwise malformed response, a response with missing data, etc.). As indicated in block 364, the system 100 may determine the status based on a latency in performing the compute operation. For example, the system 100 may determine that a malfunction is present if the node 140, 142, 144, 146, 148, 149 takes longer than a defined amount of time to complete the operation. The system 100 may determine whether the status is indicative of a malfunction using a traffic manager device upstream of the applicable node 140, 142, 144, 146, 148, 149 in the application cluster 130, 132, as indicated in block 366. That is, in at least some embodiments, a local traffic manager 120, 122 may determine whether the response or lack thereof from the corresponding node indicates a malfunction (e.g., based on an error indicated in the response or a latency associated with the response). In some embodiments, the traffic distributor (e.g., also a traffic manage device upstream of the applicable node 140, 142, 144, 146, 148, 149) may perform the determination as to whether the response or lack thereof is indicative of a malfunction. Accordingly, as indicated above, the determination as to whether a malfunction is present may be performed by various devices of the system 100.

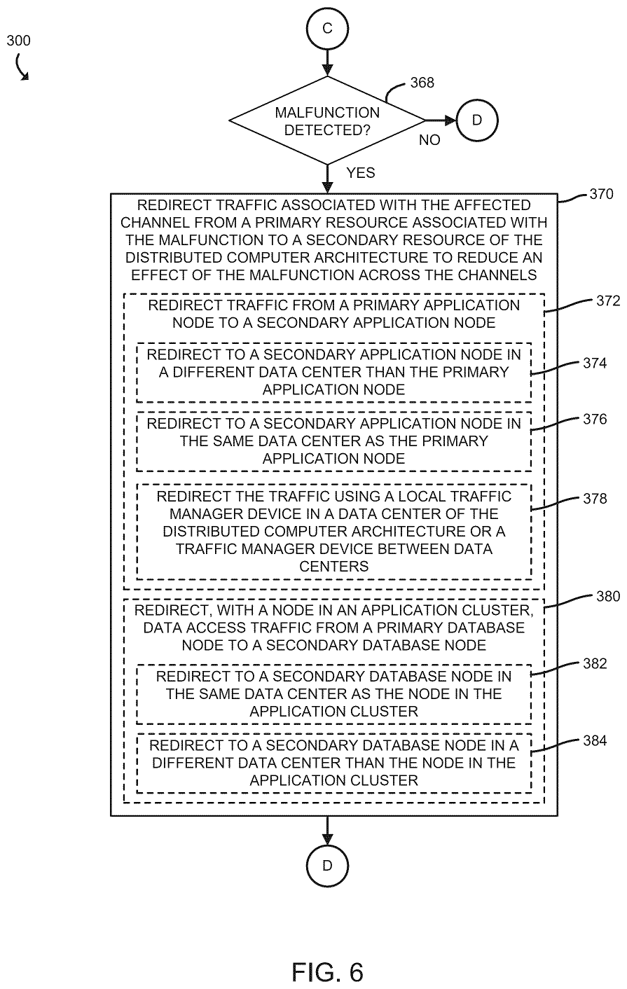

Referring now to FIG. 6, in block 368, the system 100 determines a responsive course of action based on whether a malfunction has been detected (e.g., from block 332). If a malfunction has not been detected, the method 300 loops back to block 302 of FIG. 3, in which the system 100 continues to perform operations associated with the channels 102, 104, 106. Otherwise, if a malfunction has been detected, the method 300 advances to block 370, in which the system 100 redirects traffic associated with the affected channel 102, 104, 106 (e.g., the channel for which a resource (e.g., a node in an application cluster or a node in a database cluster) has a malfunction). In doing so, the system 100 redirects the traffic from a primary resource (e.g., a first resource) to a secondary resource of the distributed computer architecture to reduce an effect of the malfunction across the channels 102, 104, 106. That is, the system 100 isolates (e.g., contains) the adverse effects of the detected malfunction and redirects traffic to enable continued operations for all of the channels 102, 104, 106. Accordingly, the system 100 avoids a single point of failure that would cause more widespread or complete interruption of operations in a conventional system.

As indicated in block 372, the system 100 may redirect traffic from a primary application node to a secondary application node. That is, the system 100 may redirect traffic associated with a channel 102, 104, 106 from one node (e.g., a node 140, 142, 144, 146, 148, 149) in an application cluster 130, 132 to a different node (e.g., a node 140, 142, 144, 146, 148, 149) in an application cluster 130, 132. The system 100 may perform the redirection among nodes of the application layer in response to a determination that a malfunction was detected as a result of a compute operation (i.e., rather than a data access operation). In doing so, and as indicated in block 374, the system 100 may redirect the traffic to a second application node in a different data center than the primary application node. For example, the system 100 may redirect traffic associated with a channel (e.g., the channel 102) that was initially directed to the node 140 in the data center 112 to instead be transmitted to the node 146 in the data center 114. As indicated in block 376, the system 100 may redirect the traffic to a second application node in the same data center as the primary application node. That is, the system 100 may redirect traffic associated with a channel (e.g., the channel 102) from one node in the cluster 130 to another node in the cluster 130, in the same data center 112. The system 100 may redirect the traffic (e.g., in accordance with blocks 374 or 376) using a local traffic manager device (e.g., a local traffic manager 120, 122) of the distributed computer architecture or a traffic manager device between data centers (e.g., the traffic distributor 110 between the data centers 112, 114), as indicated in block 378.

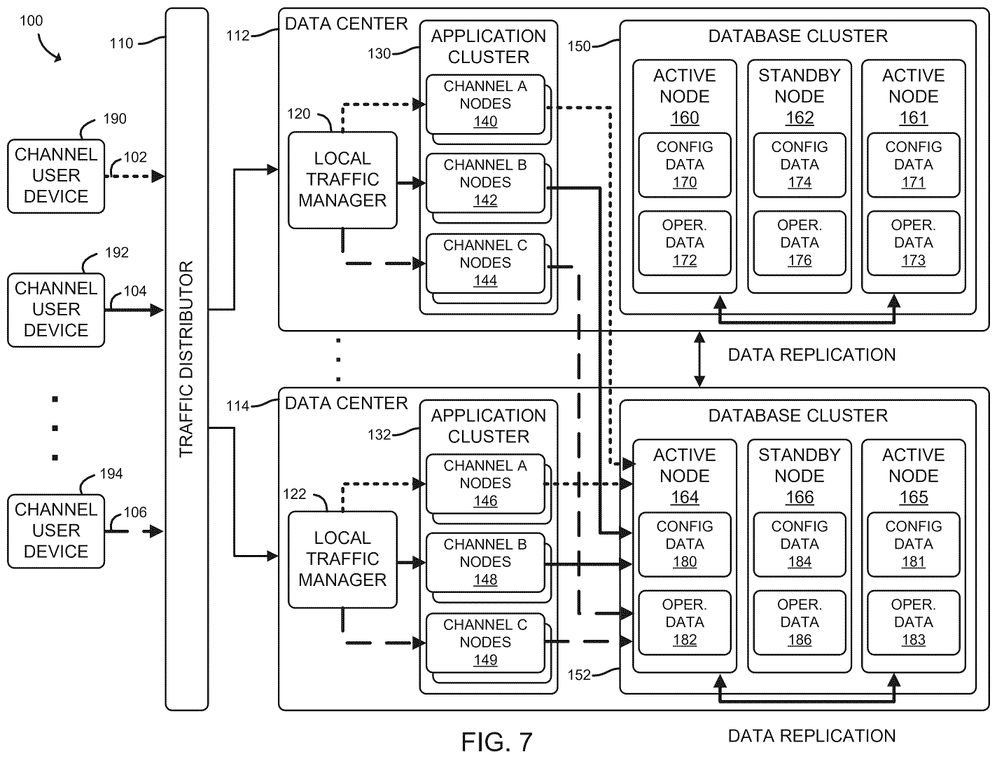

Similarly, as indicated in block 380, the system 100 may redirect, with a node 140, 142, 144, 146, 148, 149 in an application cluster 130, 132, data access traffic from a primary database node to a secondary database node (e.g., from one node 160, 161, 162, 164, 165, 166 in a database cluster 150, 152 to another node in a database cluster 150, 152). In doing so, and as indicated in block 382, the system 100 may redirect traffic to a secondary database node in the same data center as the node 140, 142, 144, 146, 148, 149 (e.g., establishing the traffic redirection) in the application cluster 130, 132. For example, the node 140 in the application cluster 130 in the data center 112 may redirect data access requests associated with the channel 102 from the node 160 of the database cluster 150 in the data center 112 to the node 162 of the database cluster 150 in the data center 112. As indicated in block 384, the system 100 (e.g., a node in an application cluster 130, 132) may redirect traffic associated with a channel to a secondary database node in a different data center than the node in the application cluster. For example, the node 140 in the data center 112 may redirect data access requests associated with the channel 102 from the node 160 of the database cluster 150 in the data center 112 to the node 164 of the database cluster 152 in the data center 114. In at least some embodiments, application nodes associated with the same channel (e.g., the channel 102) may coordinate (e.g., communicate one or more messages indicative of a determination) to switch traffic (e.g., data access requests) from one database node (e.g., the node 160) to another database node (the node 164) concurrently (e.g., in response to a determination that a malfunction is present in the node 160). An example reconfiguration of traffic is shown in FIG. 7, in which the nodes 140, 142, 144 at the application layer (e.g., of the application cluster 130) in the data center 112 have redirected traffic (e.g., data access requests) associated with the channels 102, 104, 106 (channels A, B, and C) from the node 160 in the database cluster 150 of the data center 112 to the node 164 in the database cluster 152 of the data center 114. After performing a redirection, to address a detected malfunction, the method 300 loops back to block 302 of FIG. 3 in which the system 100 continues to perform operations (e.g., compute and data access operations) for the channels 102, 104, 106.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### Examples

Illustrative examples of the technologies disclosed herein are provided below. An embodiment of the technologies may include any one or more, and any combination of, the examples described below.

Example 1 includes a system comprising circuitry configured to perform operations associated with multiple channels in a distributed computer architecture that includes resources in multiple data centers; determine, as a function of the performance of the operations, whether a status of a resource in the distributed computer architecture is indicative of a malfunction, including determining a channel affected by the malfunction; and redirect traffic associated with the affected channel from the resource associated with the malfunction to a secondary resource of the distributed architecture to reduce an effect of the malfunction across the channels.

Example 2 includes the subject matter of Example 1, and wherein to perform operations comprises to perform operations for a channel associated with web based interactions.

Example 3 includes the subject matter of any of Examples 1 and 2, and wherein to perform operations comprises to perform operations for a channel associated with mobile based interactions.

Example 4 includes the subject matter of any of Examples 1-3, and wherein to perform operations comprises to perform operations for a channel associated with help center based interactions.

Example 5 includes the subject matter of any of Examples 1-4, and wherein to perform operations comprises to perform database access operations using a dynamic connection defined between an application node and a database node for each channel.

Example 6 includes the subject matter of any of Examples 1-5, and wherein to perform operations comprises to perform database access operations using a dynamic connection defined between an application node in one data center and a database node in the same data center.

Example 7 includes the subject matter of any of Examples 1-6, and wherein to perform operations comprises to perform database access operations using a dynamic connection defined between an application node in a first data center and a database node in a second data center.

Example 8 includes the subject matter of any of Examples 1-7, and wherein to perform operations comprises to perform database access operations for a channel of the multiple channels using application nodes in multiple data centers.

Example 9 includes the subject matter of any of Examples 1-8, and wherein to perform operations comprises to perform operations associated with the channels using nodes in corresponding clusters in each of the multiple data centers.

Example 10 includes the subject matter of any of Examples 1-9, and wherein to perform operations associated with the channels using nodes in corresponding clusters comprises to perform the operations using nodes in application clusters and database clusters.

Example 11 includes the subject matter of any of Examples 1-10, and wherein to perform operations associated with the channels using nodes in corresponding clusters comprises to perform the operations using clusters of containers.

Example 12 includes the subject matter of any of Examples 1-11, and wherein to perform operations associated with the channels using nodes in corresponding clusters comprises to perform the operations using clusters of virtual machines.

Example 13 includes the subject matter of any of Examples 1-12, and wherein the circuitry is further configured to orchestrate user identification across the multiple data centers.

Example 14 includes the subject matter of any of Examples 1-13, and wherein the circuitry is further configured to orchestrate user identification across the multiple channels.

Example 15 includes the subject matter of any of Examples 1-14, and wherein the circuitry is further configured to continually replicate data across database clusters of the multiple data centers.

Example 16 includes the subject matter of any of Examples 1-15, and wherein to determine whether a status of a resource in the distributed computer architecture is indicative of a malfunction comprises to determine whether the status is indicative of a present malfunction or an impending malfunction of the resource.

Example 17 includes the subject matter of any of Examples 1-16, and wherein to determine whether a status of a resource in the distributed computer architecture is indicative of a malfunction comprises to determine whether the status is indicative of a malfunction of a compute resource.

Example 18 includes the subject matter of any of Examples 1-17, and wherein to determine whether the status is indicative of a malfunction of a compute resource comprises to determine whether the status is indicative of a malfunction of a node in an application cluster.

Example 19 includes the subject matter of any of Examples 1-18, and wherein to determine whether a status of a resource in the distributed computer architecture is indicative of a malfunction comprises to determine whether the status is indicative of a malfunction of a database resource.

Example 20 includes the subject matter of any of Examples 1-19, and wherein to determine whether the status is indicative of a malfunction of a database resource comprises to determine whether the status is indicative of a malfunction of a node in a database cluster.

Example 21 includes the subject matter of any of Examples 1-20, and wherein to determine whether the status is indicative of a malfunction comprises to determine whether the status is indicative of a malfunction based on a result of a data access operation.

Example 22 includes the subject matter of any of Examples 1-21, and wherein to determine whether the status is indicative of a malfunction based on a result of a data access operation comprises to determine whether the status is indicative of a malfunction based on a read or write operation to be performed by a database cluster.

Example 23 includes the subject matter of any of Examples 1-22, and wherein to determine whether the status is indicative of a malfunction based on a result of a data access operation comprises to determine the status using a database connection driver associated with a node of an application cluster.

Example 24 includes the subject matter of any of Examples 1-23, and wherein to determine whether the status is indicative of a malfunction comprises to determine whether the status is indicative of a malfunction based on a result of a compute operation.

Example 25 includes the subject matter of any of Examples 1-24, and wherein to determine whether the status is indicative of a malfunction based on a result of a compute operation comprises to determine whether the status is indicative of a malfunction based on a result of an operation to be performed to by a node in an application cluster.

Example 26 includes the subject matter of any of Examples 1-25, and wherein to determine the status comprises to determine the status using a traffic manager device upstream of the node in the application cluster.

Example 27 includes the subject matter of any of Examples 1-26, and wherein to determine whether the status is indicative of a malfunction comprises to determine the status based on an error resulting from the operation.

Example 28 includes the subject matter of any of Examples 1-27, and wherein to determine whether the status is indicative of a malfunction comprises to determine the status based on a latency in performing the operation.

Example 29 includes the subject matter of any of Examples 1-28, and wherein to redirect traffic comprises to redirect traffic from a primary application node to a secondary application node.

Example 30 includes the subject matter of any of Examples 1-29, and wherein to redirect traffic from a primary application node to a secondary application node comprises to redirect traffic to a secondary application node in a different data center than the primary application node.

Example 31 includes the subject matter of any of Examples 1-30, and wherein to redirect traffic from a primary application node to a secondary application node comprises to redirect traffic to a secondary application node in the same data center as the primary application node.

Example 32 includes the subject matter of any of Examples 1-31, and wherein to redirect traffic from a primary application node to a secondary application node comprises to redirect the traffic using a local traffic manager device in a data center of the distributed computer architecture.

Example 33 includes the subject matter of any of Examples 1-32, and wherein to redirect traffic from a primary application node to a secondary application node comprises to redirect the traffic using a traffic manager device between data centers of the distributed computer architecture.

Example 34 includes the subject matter of any of Examples 1-33, and wherein to redirect traffic comprises to redirect, with a node in an application cluster, data access traffic from a primary database node to a secondary database node.

Example 35 includes the subject matter of any of Examples 1-34, and wherein to redirect traffic further comprises to redirect the traffic to a secondary database node in the same data center as the node in the application cluster.

Example 36 includes the subject matter of any of Examples 1-35, and wherein to redirect traffic further comprises to redirect the traffic to a secondary database node in a different data center than the node in the application cluster.

Example 37 includes a method comprising performing, by a system of compute devices, operations associated with multiple channels in a distributed computer architecture that includes resources in multiple data centers; determining, by the system and as a function of the performance of the operations, whether a status of a resource in the distributed computer architecture is indicative of a malfunction, including determining a channel affected by the malfunction; and redirecting, by the system, traffic associated with the affected channel from the resource associated with the malfunction to a secondary resource of the distributed architecture to reduce an effect of the malfunction across the channels.

Example 38 includes the subject matter of Example 37, and wherein performing operations comprises performing operations for a channel associated with web based interactions.

Example 39 includes the subject matter of any of Examples 37 and 38, and wherein performing operations comprises performing operations for a channel associated with mobile based interactions.

Example 40 includes the subject matter of any of Examples 37-39, and wherein performing operations comprises performing operations for a channel associated with help center based interactions.

Example 41 includes the subject matter of any of Examples 37-40, and wherein performing operations comprises performing database access operations using a dynamic connection defined between an application node and a database node for each channel.

Example 42 includes the subject matter of any of Examples 37-41, and wherein performing operations comprises performing database access operations using a dynamic connection defined between an application node in one data center and a database node in the same data center.

Example 43 includes the subject matter of any of Examples 37-42, and wherein performing operations comprises performing database access operations using a dynamic connection defined between an application node in a first data center and a database node in a second data center.

Example 44 includes the subject matter of any of Examples 37-43, and wherein performing operations comprises performing database access operations for a channel of the multiple channels using application nodes in multiple data centers.

Example 45 includes the subject matter of any of Examples 37-44, and wherein performing operations comprises performing operations associated with the channels using nodes in corresponding clusters in each of the multiple data centers.

Example 46 includes the subject matter of any of Examples 37-45, and wherein performing operations associated with the channels using nodes in corresponding clusters comprises performing the operations using nodes in application clusters and database clusters.

Example 47 includes the subject matter of any of Examples 37-46, and wherein performing operations associated with the channels using nodes in corresponding clusters comprises performing the operations using clusters of containers.

Example 48 includes the subject matter of any of Examples 37-47, and wherein performing operations associated with the channels using nodes in corresponding clusters comprises performing the operations using clusters of virtual machines.

Example 49 includes the subject matter of any of Examples 37-48, and further including orchestrating, by the system, user identification across the multiple data centers.

Example 50 includes the subject matter of any of Examples 37-49, and further including orchestrating, by the system, user identification across the multiple channels.

Example 51 includes the subject matter of any of Examples 37-50, and further including continually replicating, by the system, data across database clusters of the multiple data centers.

Example 52 includes the subject matter of any of Examples 37-51, and wherein determining whether a status of a resource in the distributed computer architecture is indicative of a malfunction comprises determining whether the status is indicative of a present malfunction or an impending malfunction of the resource.

Example 53 includes the subject matter of any of Examples 37-52, and wherein determining whether a status of a resource in the distributed computer architecture is indicative of a malfunction comprises determining whether the status is indicative of a malfunction of a compute resource.

Example 54 includes the subject matter of any of Examples 37-53, and wherein determining whether the status is indicative of a malfunction of a compute resource comprises determining whether the status is indicative of a malfunction of a node in an application cluster.

Example 55 includes the subject matter of any of Examples 37-54, and wherein determining whether a status of a resource in the distributed computer architecture is indicative of a malfunction comprises determining whether the status is indicative of a malfunction of a database resource.

Example 56 includes the subject matter of any of Examples 37-55, and wherein determining whether the status is indicative of a malfunction of a database resource comprises determining whether the status is indicative of a malfunction of a node in a database cluster.

Example 57 includes the subject matter of any of Examples 37-56, and wherein determining whether the status is indicative of a malfunction comprises determining whether the status is indicative of a malfunction based on a result of a data access operation.

Example 58 includes the subject matter of any of Examples 37-57, and wherein determining whether the status is indicative of a malfunction based on a result of a data access operation comprises determining whether the status is indicative of a malfunction based on a read or write operation to be performed by a database cluster.

Example 59 includes the subject matter of any of Examples 37-58, and wherein determining whether the status is indicative of a malfunction based on a result of a data access operation comprises determining the status using a database connection driver associated with a node of an application cluster.

Example 60 includes the subject matter of any of Examples 37-59, and wherein determining whether the status is indicative of a malfunction comprises determining whether the status is indicative of a malfunction based on a result of a compute operation.

Example 61 includes the subject matter of any of Examples 37-60, and wherein determining whether the status is indicative of a malfunction based on a result of a compute operation comprises determining whether the status is indicative of a malfunction based on a result of an operation to be performed by a node in an application cluster.

Example 62 includes the subject matter of any of Examples 37-61, and wherein determining the status comprises determining the status using a traffic manager device upstream of the node in the application cluster.

Example 63 includes the subject matter of any of Examples 37-62, and wherein determining whether the status is indicative of a malfunction comprises determining the status based on an error resulting from the operation.

Example 64 includes the subject matter of any of Examples 37-63, and wherein determining whether the status is indicative of a malfunction comprises determining the status based on a latency in performing the operation.

Example 65 includes the subject matter of any of Examples 37-64, and wherein redirecting traffic comprises redirecting traffic from a primary application node to a secondary application node.

Example 66 includes the subject matter of any of Examples 37-65, and wherein redirecting traffic from a primary application node to a secondary application node comprises redirecting traffic to a secondary application node in a different data center than the primary application node.

Example 67 includes the subject matter of any of Examples 37-66, and wherein redirecting traffic from a primary application node to a secondary application node comprises redirecting traffic to a secondary application node in the same data center as the primary application node.

Example 68 includes the subject matter of any of Examples 37-67, and wherein redirecting traffic from a primary application node to a secondary application node comprises redirecting the traffic using a local traffic manager device in a data center of the distributed computer architecture.

Example 69 includes the subject matter of any of Examples 37-68, and wherein redirecting traffic from a primary application node to a secondary application node comprises redirecting the traffic using a traffic manager device between data centers of the distributed computer architecture.

Example 70 includes the subject matter of any of Examples 37-69, and wherein redirecting traffic comprises redirecting, with a node in an application cluster, data access traffic from a primary database node to a secondary database node.

Example 71 includes the subject matter of any of Examples 37-70, and wherein redirecting traffic further comprises redirecting the traffic to a secondary database node in the same data center as the node in the application cluster.

Example 72 includes the subject matter of any of Examples 37-71, and wherein redirecting traffic further comprises redirecting the traffic to a secondary database node in a different data center than the node in the application cluster.

Example 73 includes one or more machine-readable storage media comprising a plurality of instructions stored thereon that, in response to being executed, cause a system to perform operations associated with multiple channels in a distributed computer architecture that includes resources in multiple data centers; determine, as a function of the performance of the operations, whether a status of a resource in the distributed computer architecture is indicative of a malfunction, including determining a channel affected by the malfunction; and redirect traffic associated with the affected channel from the resource associated with the malfunction to a secondary resource of the distributed architecture to reduce an effect of the malfunction across the channels.

Example 74 includes the subject matter of Example 73, and wherein to perform operations comprises to perform operations for a channel associated with web based interactions.

Example 75 includes the subject matter of any of Examples 73 and 74, and wherein to perform operations comprises to perform operations for a channel associated with mobile based interactions.

Example 76 includes the subject matter of any of Examples 73-75, and wherein to perform operations comprises to perform operations for a channel associated with help center based interactions.

Example 77 includes the subject matter of any of Examples 73-76, and wherein to perform operations comprises to perform database access operations using a dynamic connection defined between an application node and a database node for each channel.

Example 78 includes the subject matter of any of Examples 73-77, and wherein to perform operations comprises to perform database access operations using a dynamic connection defined between an application node in one data center and a database node in the same data center.

Example 79 includes the subject matter of any of Examples 73-78, and wherein to perform operations comprises to perform database access operations using a dynamic connection defined between an application node in a first data center and a database node in a second data center.

Example 80 includes the subject matter of any of Examples 73-79, and wherein to perform operations comprises to perform database access operations for a channel of the multiple channels using application nodes in multiple data centers.

Example 81 includes the subject matter of any of Examples 73-80, and wherein to perform operations comprises to perform operations associated with the channels using nodes in corresponding clusters in each of the multiple data centers.

Example 82 includes the subject matter of any of Examples 73-81, and wherein to perform operations associated with the channels using nodes in corresponding clusters comprises to perform the operations using nodes in application clusters and database clusters.

Example 83 includes the subject matter of any of Examples 73-82, and wherein to perform operations associated with the channels using nodes in corresponding clusters comprises to perform the operations using clusters of containers.

Example 84 includes the subject matter of any of Examples 73-83, and wherein to perform operations associated with the channels using nodes in corresponding clusters comprises to perform the operations using clusters of virtual machines.

Example 85 includes the subject matter of any of Examples 73-84, and wherein the instructions additionally cause the system to orchestrate user identification across the multiple data centers.

Example 86 includes the subject matter of any of Examples 73-85, and wherein the instructions additionally cause the system to orchestrate user identification across the multiple channels.

Example 87 includes the subject matter of any of Examples 73-86, and wherein the instructions additionally cause the system to continually replicate data across database clusters of the multiple data centers.

Example 88 includes the subject matter of any of Examples 73-87, and wherein to determine whether a status of a resource in the distributed computer architecture is indicative of a malfunction comprises to determine whether the status is indicative of a present malfunction or an impending malfunction of the resource.

Example 89 includes the subject matter of any of Examples 73-88, and wherein to determine whether a status of a resource in the distributed computer architecture is indicative of a malfunction comprises to determine whether the status is indicative of a malfunction of a compute resource.

Example 90 includes the subject matter of any of Examples 73-89, and wherein to determine whether the status is indicative of a malfunction of a compute resource comprises to determine whether the status is indicative of a malfunction of a node in an application cluster.

Example 91 includes the subject matter of any of Examples 73-90, and wherein to determine whether a status of a resource in the distributed computer architecture is indicative of a malfunction comprises to determine whether the status is indicative of a malfunction of a database resource.

Example 92 includes the subject matter of any of Examples 73-91, and wherein to determine whether the status is indicative of a malfunction of a database resource comprises to determine whether the status is indicative of a malfunction of a node in a database cluster.

Example 93 includes the subject matter of any of Examples 73-92, and wherein to determine whether the status is indicative of a malfunction comprises to determine whether the status is indicative of a malfunction based on a result of a data access operation.

Example 94 includes the subject matter of any of Examples 73-93, and wherein to determine whether the status is indicative of a malfunction based on a result of a data access operation comprises to determine whether the status is indicative of a malfunction based on a read or write operation to be performed by a database cluster.

Example 95 includes the subject matter of any of Examples 73-94, and wherein to determine whether the status is indicative of a malfunction based on a result of a data access operation comprises to determine the status using a database connection driver associated with a node of an application cluster.

Example 96 includes the subject matter of any of Examples 73-95, and wherein to determine whether the status is indicative of a malfunction comprises to determine whether the status is indicative of a malfunction based on a result of a compute operation.

Example 97 includes the subject matter of any of Examples 73-96, and wherein to determine whether the status is indicative of a malfunction based on a result of a compute operation comprises to determine whether the status is indicative of a malfunction based on a result of an operation to be performed to by a node in an application cluster.

Example 98 includes the subject matter of any of Examples 73-97, and wherein to determine the status comprises to determine the status using a traffic manager device upstream of the node in the application cluster.

Example 99 includes the subject matter of any of Examples 73-98, and wherein to determine whether the status is indicative of a malfunction comprises to determine the status based on an error resulting from the operation.

Example 100 includes the subject matter of any of Examples 73-99, and wherein to determine whether the status is indicative of a malfunction comprises to determine the status based on a latency in performing the operation.

Example 101 includes the subject matter of any of Examples 73-100, and wherein to redirect traffic comprises to redirect traffic from a primary application node to a secondary application node.

Example 102 includes the subject matter of any of Examples 73-101, and wherein to redirect traffic from a primary application node to a secondary application node comprises to redirect traffic to a secondary application node in a different data center than the primary application node.

Example 103 includes the subject matter of any of Examples 73-102, and wherein to redirect traffic from a primary application node to a secondary application node comprises to redirect traffic to a secondary application node in the same data center as the primary application node.

Example 104 includes the subject matter of any of Examples 73-103, and wherein to redirect traffic from a primary application node to a secondary application node comprises to redirect the traffic using a local traffic manager device in a data center of the distributed computer architecture.

Example 105 includes the subject matter of any of Examples 73-104, and wherein to redirect traffic from a primary application node to a secondary application node comprises to redirect the traffic using a traffic manager device between data centers of the distributed computer architecture.

Example 106 includes the subject matter of any of Examples 73-105, and wherein to redirect traffic comprises to redirect, with a node in an application cluster, data access traffic from a primary database node to a secondary database node.

Example 107 includes the subject matter of any of Examples 73-106, and wherein to redirect traffic further comprises to redirect the traffic to a secondary database node in the same data center as the node in the application cluster.

Example 108 includes the subject matter of any of Examples 73-107, and wherein to redirect traffic further comprises to redirect the traffic to a secondary database node in a different data center than the node in the application cluster.

1. A system comprising:
circuitry configured to:
perform operations associated with multiple channels in a distributed computer architecture that includes resources in multiple data centers;
determine, as a function of the performance of the operations, whether a status of a resource in the distributed computer architecture is indicative of a malfunction, including determining a channel affected by the malfunction; and
redirect traffic associated with the affected channel from the resource associated with the malfunction to a secondary resource of the distributed architecture to reduce an effect of the malfunction across the channels.

2. The system of claim 1, wherein the circuitry is further configured to orchestrate user identification across the multiple data centers and/or multiple channels.

3. The system of claim 1, wherein the circuitry is further configured to continually replicate data across database clusters of the multiple data centers.

4. The system of claim 1, wherein to determine whether a status of a resource in the distributed computer architecture is indicative of a malfunction comprises to determine whether the status is indicative of a present malfunction or an impending malfunction of the resource.

5. The system of claim 1, wherein to determine whether a status of a resource in the distributed computer architecture is indicative of a malfunction comprises to determine whether the status is indicative of a malfunction of a compute resource.

6. The system of claim 5, wherein to determine whether the status is indicative of a malfunction of a compute resource comprises to determine whether the status is indicative of a malfunction of a node in an application cluster.

7. The system of claim 1, wherein to determine whether a status of a resource in the distributed computer architecture is indicative of a malfunction comprises to determine whether the status is indicative of a malfunction of a database resource.

8. The system of claim 7, wherein to determine whether the status is indicative of a malfunction of a database resource comprises to determine whether the status is indicative of a malfunction of a node in a database cluster.

9. The system of claim 1, wherein to determine whether the status is indicative of a malfunction comprises to determine whether the status is indicative of a malfunction based on a result of a data access operation.

10. The system of claim 9, wherein to determine whether the status is indicative of a malfunction based on a result of a data access operation comprises to determine whether the status is indicative of a malfunction based on a read or write operation to be performed by a database cluster.

11. The system of claim 9, wherein to determine whether the status is indicative of a malfunction based on a result of a data access operation comprises to determine the status using a database connection driver associated with a node of an application cluster.

12. The system of claim 1, wherein to determine whether the status is indicative of a malfunction comprises to determine whether the status is indicative of a malfunction based on a result of a compute operation.

13. The system of claim 12, wherein to determine whether the status is indicative of a malfunction based on a result of a compute operation comprises to determine whether the status is indicative of a malfunction based on a result of an operation to be performed to by a node in an application cluster.

14. The system of claim 13, wherein to determine the status comprises to determine the status using a traffic manager device upstream of the node in the application cluster.

15. The system of claim 1, wherein to determine whether the status is indicative of a malfunction comprises to determine the status based on an error resulting from the operation.

16. The system of claim 1, wherein to determine whether the status is indicative of a malfunction comprises to determine the status based on a latency in performing the operation.

17. The system of claim 1, wherein to redirect traffic comprises to redirect traffic from a primary application node to a secondary application node.

18. The system of claim 17, wherein to redirect traffic from a primary application node to a secondary application node comprises to redirect traffic to a secondary application node in a different data center than the primary application node.

19. The system of claim 17, wherein to redirect traffic from a primary application node to a secondary application node comprises to redirect traffic to a secondary application node in the same data center as the primary application node.

20. The system of claim 17, wherein to redirect traffic from a primary application node to a secondary application node comprises to redirect the traffic using a local traffic manager device in a data center of the distributed computer architecture.

21. The system of claim 17, wherein to redirect traffic from a primary application node to a secondary application node comprises to redirect the traffic using a traffic manager device between data centers of the distributed computer architecture.

22. The system of claim 1, wherein to redirect traffic comprises to redirect, with a node in an application cluster, data access traffic from a primary database node to a secondary database node.

23. The system of claim 22, wherein to redirect traffic further comprises to redirect the traffic to a secondary database node in the same data center as the node in the application cluster.

24. The system of claim 23, wherein to redirect traffic further comprises to redirect the traffic to a secondary database node in a different data center than the node in the application cluster.
